(19) United States
(12) Patent Application Publication
(10) Pub. No.: US 2009/0327509 A1
(43) Pub. Date: Dec. 31, 2009

(54) METHOD FOR THE DIFFUSION OF INFORMATION IN A DISTRIBUTED NETWORK

(76) Inventors: Joris Roussel, Paris (FR); Clément Moreau, Issy-Les-Moulineaux (FR)

Correspondence Address: Robert D. Shedd, Patent Operations;THOMSON Licensing LLC, P.O. Box 5312, Princeton, NJ, 08543-5312, US

(21) Appl. No.: 12/309,902

(22) PCT Filed: Aug. 8, 2007
(86) PCT No.: PCT/FR2007/051798

§ 371 Date: Feb. 2, 2009

(30) Foreign Application Priority Data
Aug. 10, 2006 (FR) 0653349

(51) Int. Cl. G06F 15/16; G06F 15/173

(52) U.S. Cl. 709/231; 709/242

(57) ABSTRACT

The present invention relates to a communication network for the diffusion of media content from a public content server to a central private server and a plurality of client stations connected logically to the private server and amongst each other by a communication sub-network, wherein said sub-network is disturbed, has a hierarchical structure and is built dynamically based on the load at the level of the server and client stations. The invention further relates to an association method between a client station and a central server or between a client station and another client station/server in a hierarchical communication network comprising at least one central server and a plurality of client stations. Lastly, the present invention further relates to a communication terminal

### SCOPE OF THE INVENTION

The present invention relates to the domain of Information and Communication Technologies.

The present invention more specifically relates to a method for the diffusion of data in a distributed network.

### PRIOR ART

In the prior art, information diffusion techniques are already known (broadcasting). This diffusion carried out regularly (almost in real time) is traditionally realized in one of the following ways: by broadcast (or its multicast variant) or by unicast.

The broadcast methods consist in the transmission of information only once for all the client terminals that “listen for” this information. This technique is very efficient on the server side. However, this technique presents two important disadvantages:
it is necessary to have an adapted network infrastructure,
this technique is very inefficient in terms of bandwidth if multiple data streams have to be diffused at the same time.

The multicast technique is a variant of the broadcast mechanism in which he (or she) who is listening for a specific data stream registers with the network infrastructure and servers. Due to this registering process, the network is able to avoid diffusing specific data streams in parts of the network where no “listener” terminal is interested by that stream. This mechanism enables saving bandwidth in the access network that is the part of the network between the final user and the core network part. The drawbacks of such methods are the following:
they are based on the capacity of the low layer to process multicast, that is not well deployed in current networks,
they do not enable reduction of bandwidth in the core network part.

The unicast technique consists in the transmission of information individually from the server to each listener terminal. This technique can be used in “push” mode (data streams are pushed by the server to the final users), in a similar manner to the methods for broadcast, or in “pull” mode (the user terminal extracts data streams from the server). The “pull” variant is currently widely deployed, particularly via Web protocols and Web servers. The main drawback of the unicast technique is that it is not economical of server resources. In addition, it is difficult to extend this technique to a large network constituted of similar devices.

The RSS (Really Simple Syndication) or Atom technologies, which are unicast techniques in pull mode, are already known in the prior art. In the scope of these two technologies, a terminal regularly interrogates a server and creates the illusion with regard to the user that the data has been sent to the terminal. The problem that is posed is the overloading of the network, in terms of bandwidth.

Today, it is possible to transmit data to a DECT (Digital Enhanced Cordless Telecommunications) terminal. The aim is to use resources shared between several users. The central problem posed is how to distribute data without overloading the network.

The prior art knows, through the U.S. Pat. No. 7,047,315 (Cisco Technology), a method for routing data via one or more load-sharing routers to a selected server, having a shared load, among a plurality of servers in a network.

The prior art also knows, from the US patent application No. US 2003/217172 (Intel), a method for transmitting a shared load in environments at varied speeds.

### SUMMARY OF THE INVENTION

In the context of the present invention, various items of end-user client equipment communicate between themselves to dynamically create a hierarchical equipment network that enables downward circulation of data (from a main server to all users).

The present invention differs from the solutions of the prior art U.S. Pat. No. 7,047,315 and US 2003/217 172 in that:
the present invention relates to “end-user items of equipment” and not to dedicated servers,
the network in the context of the present invention is dynamically created, disassembled and repaired,
data, in the context of the present invention, is diffused only to nodes that are interested in it: only the nodes interested by a particular data stream participate in the hierarchy related to this stream.

The present invention intends to overcome the drawbacks of the prior art by proposing a data diffusion mechanism almost in real time in a large scale network. It is understood that the data stream is directed from a content server to a client terminal (a PC or other type of network device). One of the aims of the present invention is to facilitate data diffusion.

For this purpose, the present invention relates to, in its most generally accepted sense, a communication terminal (T1) adapted to connect in a network to other communication terminals (T2, T3) and to a server and adapted to receive and transmit data streams, characterized in that it comprises means for establishing hierarchical links of “parent/child” type with other communication terminals or with a server, these hierarchical links being dynamically established on the basis of the load of said terminal (T1) and of the load of the terminals (T2, T3) directly or indirectly connected to it, as well as on the basis of the load of said server.

Preferably, said communication terminal comprises means for establishing, in the context of hierarchical links, a data-stream tree structure.

The present invention also relates to a method for association between a client terminal and a central server or between a client terminal and another client/server terminal in a hierarchical communication network comprising at least a central server and a plurality of client terminals, some of the client terminals also being servers and “parents” and others being “children” in said network, characterized in that it comprises the following steps:
a) a step of requesting, from a client terminal that wishes to receive a given stream, for association with said central server,
b) a step of selecting, by the central server between the following two options:
   i) providing access to said stream on the central server to said client terminal making the request for association (the association is then terminated), or
   ii) redirecting the request for association to one of its children subscribing to the stream;
c) In the case of b)ii) another selecting step by the client/server terminal between the following two options:
   i) providing access to said stream on the client/server terminal to said client terminal making the request for association (the association is then terminated), or
   ii) redirecting the request for association to one of its children subscribing to the stream,
      the method being further characterized in that step c) is iterated until the association is terminated.

Preferably, in step b)ii), the client/server child terminal towards which the request for association is redirected, is randomly selected.

Advantageously, in step c)ii), the client/server child terminal towards which the request for association is redirected, is randomly selected.

Finally, the present invention also relates to a communication network for multimedia content diffusion from a public content server to a central private server and to a plurality of client terminals that are logically connected to said private server and to each other by a communication sub-network, characterized in that said sub-network is distributed, possesses a hierarchal structure and is dynamically constructed on the basis of the load at the level of the server and client terminals.

Preferably, the multimedia content is diffused in “push” mode.

According to an embodiment, said multimedia content is composed of a plurality of data streams and, to establish said sub-network hierarchal structure, a data-stream tree structure is constructed.

Within the context of said network hierarchical structure, some client terminals are “parents” and others are “children”. These notions are used here in their classical computing sense.

In an embodiment, the client terminals are PC type computers.

In another embodiment, the client terminals are network terminals, possibly telephony terminals, for example DECT compatible.

Advantageously, in the case of a client terminal fault, the children of the faulty terminal are able to reconnect to said private central server or to the parent of the faulty terminal.

### BRIEF DESCRIPTION OF THE DRAWINGS

The invention will be better understood from the following description of an embodiment of the invention provided as an example by referring to the annexed figures, wherein:

FIG. 1 illustrates a one-stream distributed network architecture according to the present invention,

FIG. 2 shows an association process to a server for a given stream,

FIGS. 3a and 3b illustrate examples of the association process without and with the intervention of a child server, and

FIG. 4 illustrates a two-stream distributed network architecture according to the present invention.

### DETAILED DESCRIPTION OF THE EMBODIMENTS OF THE INVENTION

The deployed terminals are used as in a peer-to-peer architecture. A hierarchal network is constructed of peers that are subscribers to the same data stream.

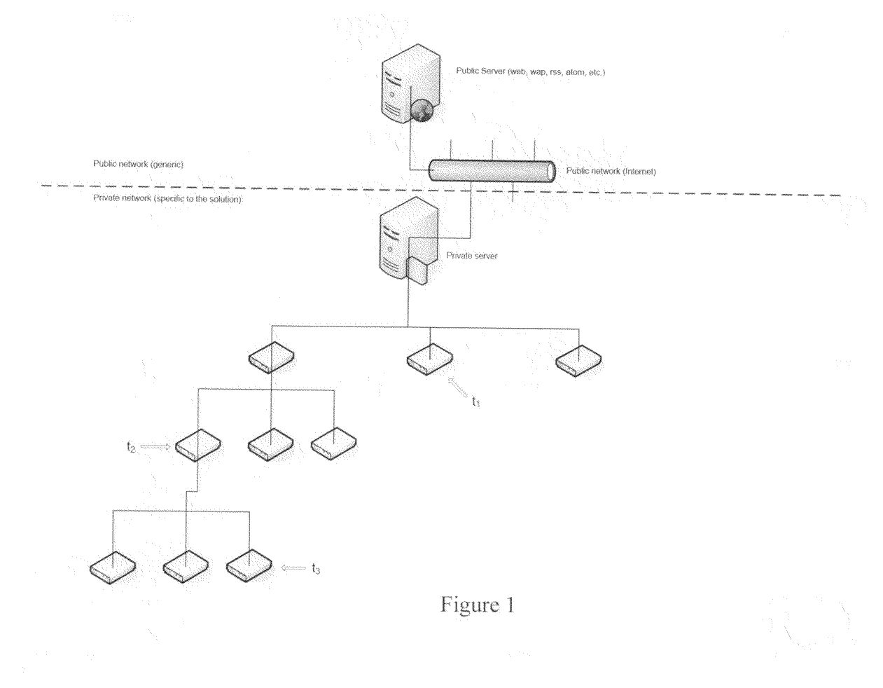

FIG. 1 illustrates a one-stream distributed network architecture according to the present invention. A tree structure with parents and children is established. There is no longer the notion of a waiting queue. Preferably, the “push” mode is used and a “per stream architecture” is established (e.g. weather, news, stock-market prices, etc.): each data stream constructs its tree structure. This network is constituted of all the subscribers (parents and children) for this same stream.

The data is extracted from a public server by a private proxy server, before being redistributed to the entire network of client terminals (for example those noted as t₁, t₂ and t₃ in FIG. 1) interested in this specific data stream.

The data can be diffused in push mode or in pull mode in the hierarchical network.

In both modes, the proxy server diffuses the data to its direct children that themselves diffuse it to their children (if any). This recursive mechanism enables diffusion of data to all the network nodes.

The tree structure is dynamically constructed on the basis of a stream. Each end user device that wishes to subscribe to a specific stream contacts the central private server for this stream. Then, it is either directly attached to the server, or redirected to one of the children of the central server. The children are able to dynamically redirect an incoming connection to one of their own children, thus creating a tree structure.

The hierarchical network is dynamically constructed on the basis of the load at the server and its client terminals.

The load can be defined as the number of connected children. For example, if the load is defined as limited to 5 connections, the 5 first children that connect to the private server or a given client can accept their association request. The next children will be redirected by their parent (private server or client) to a child of the latter.

In a more elaborate manner, the load can be a function of both the number of children and the volume of data to be diffused.

For example, for a volume of data of 50 ko, the server/client can limit the number of child connections to 10 and for a volume of 100 ko, limit then this number to 5.

Generally, this definition of the maximum load can differ between the server and its clients. The server can accept for example 100 children and the clients could accept only 20.

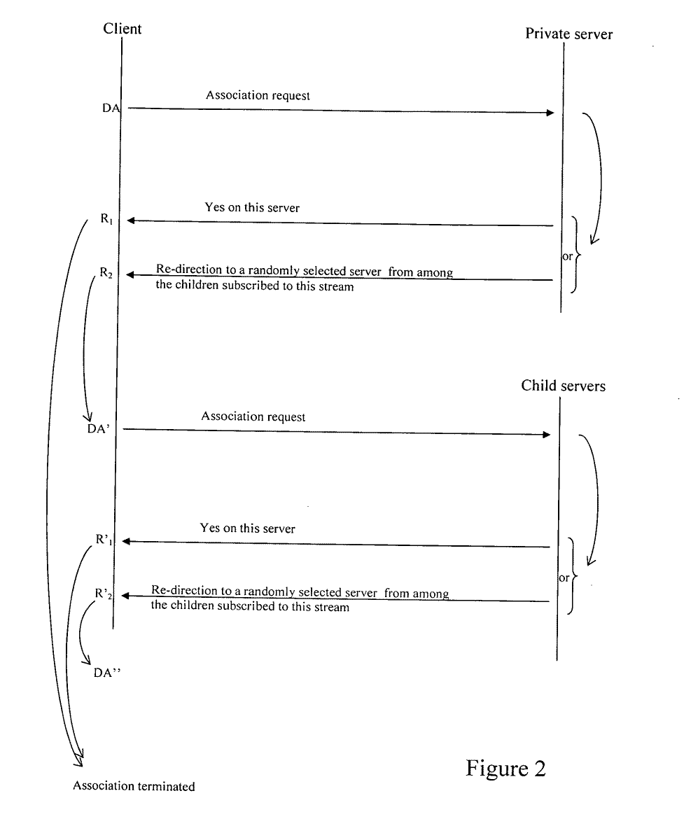

FIG. 2 shows an association process to a server for a given stream. A client terminal, that wishes to receive the stream, makes an association request (DA on FIG. 2) to the central private server. This latter has two options:
grant it access to said stream on the central private server (response R₁ on FIG. 2) and the association is terminated, or
redirect the association request to one of the children subscribing to the stream (response R₂ on FIG. 2), this child server being randomly selected. This new association request is noted as DA′ on FIG. 2.

Then, the child server has two options:
grant it access to said stream (response R′₁ on FIG. 2) and the association is terminated, or
redirect the association request to one of the children subscribing to the stream (response R′₂ on FIG. 2), this child server being randomly selected. This new association request is noted as DA′′ on FIG. 2.

This process is iterated until a server accepts to grant access to said stream.

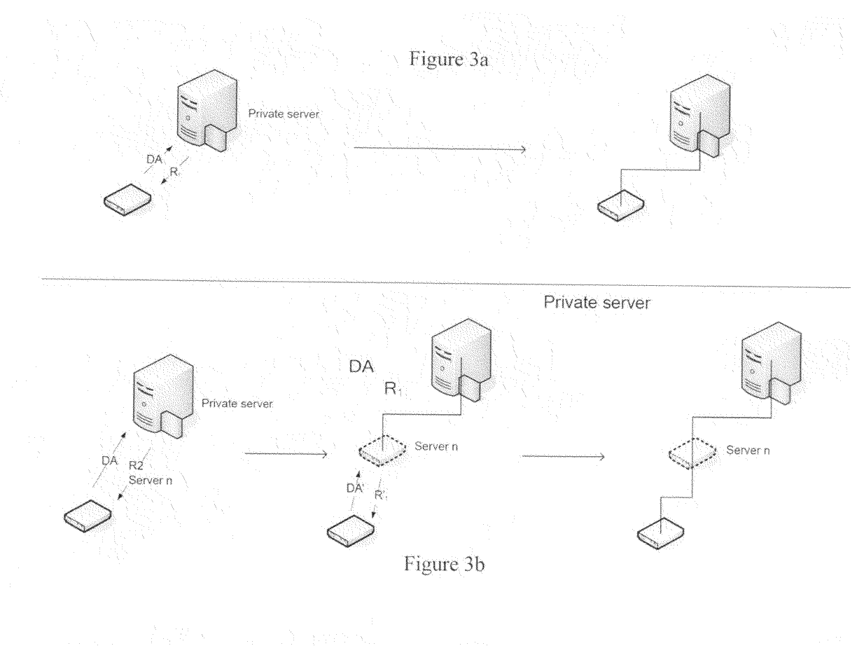

FIGS. 3a and 3b illustrate an example of association process without (FIG. 3a) and with the intervention of a child server (FIG. 3b).

In FIG. 3a, a client terminal requests access to a stream from the central private server (association request DA). This latter is not overloaded and grants access to the stream (response R₁).

In FIG. 3b, a client terminal requests access to a stream from the central private server (association request DA). This latter redirects this request to one of its children (response R₂) and an association is established between the client terminal that is requesting a stream and the child server (association request DA′ and response R′₁).

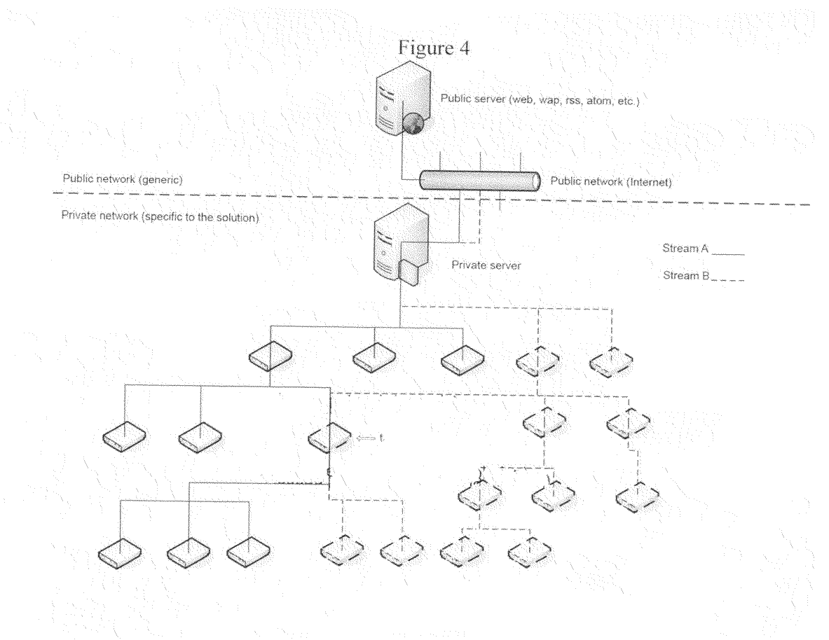

FIG. 4 illustrates the distributed network architecture with two streams, according to the present invention. Stream A is represented with a full line and stream B is represented in dots. It is noted that a child server (noted as t₁ on FIG. 4) receives the two streams.

In the case of a particular terminal fault, the children of the faulty terminal are able to reconnect to the central server or to the parent of the faulty terminal.

In addition, this system is robust: there is a function of “election of a new chief” in the case of a break in the link.

This mechanism of election of a new chief guarantees that when a client disappears from the tree structure architecture of children that were connected, it does not disappear. The first child to recognise the absence of the parent contacts the private server to obtain the coordinates of a new potential parent and hence informs the neighbouring children of the new chief.

The mechanism according to the present invention, implemented as software, can be loaded onto existing terminals without modification to the hardware.

The communications network according to the present invention presents numerous advantages:
the average load on the central server is maintained at a low level,
the bandwidth of the network is managed efficiently, in particular in the case of multiple streams, and
the data streams are almost in real time, by means of the data “push” mechanism.

The invention is described in the preceding text as an example. It is understood that those skilled in the art are capable of producing variants of the invention without leaving the scope of the patent.

1. Communication terminal adapted to connect in a network to other communication terminals and to a server, and adapted to receive and transmit data streams, comprising means for establishing hierarchical links of “parent/child” type with other communications terminals or with a server, these hierarchical links being dynamically established on the basis of the load of said terminal and of the load of the terminals that are directly or indirectly connected to it as well as on the basis of the load of said server.

2. Communication terminal according to claim 1, comprising means for establishing, in the context of hierarchical links, a tree structure per data stream.

3. Method of association between a client terminal and a central server or between a client terminal and another client/server terminal in a hierarchical communication network comprising at least a central server and a plurality of client terminals, some of the client terminals also being servers and “parents” and others being “children” in said network, comprising the following steps:
a) a step of requesting, from a client terminal that wishes to receive a given stream, for association with said central server,
b) a step of selecting, by the central server between the following two options:
i) providing access to said stream on the central server to said client terminal making the request for association (the association is then terminated), or
ii) redirecting the request for association to one of its children subscribing to the stream;
c) In the case of b)ii) another selecting step by the client/server terminal between the following two options:
i) providing access to said stream on the client/server terminal to said client terminal making the request for association (the association is then terminated), or
ii) redirecting the request for association to one of its children subscribing to the stream,
wherein step c) is iterated until the association is terminated.

4. Method of association according to claim 3 wherein in step b)ii), the client/server child terminal towards which the request for association is redirected, is randomly selected.

5. Method of association according to claim 3, wherein in step c)ii), the client/server child terminal towards which the request for association is redirected, is randomly selected.

6. Communication network for multimedia content diffusion from a public content server to a central private server and a plurality of client terminals that are logically connected to said private server and to each other by a communication sub-network, wherein said sub-network is distributed, possesses a hierarchal structure and is dynamically constructed on the basis of the load at the level of the server and client terminals.

7. Communication network for multimedia content diffusion according to claim 6 wherein the multimedia content is diffused in “push” mode.

8. Communication network for the diffusion of multimedia content according to claim 6 wherein said multimedia content is composed of a plurality of data streams and in that, to establish said hierarchical network structure, a tree structure per stream is constructed.

9. Communication network for the diffusion of multimedia content according to claim 6, wherein in the context of said sub-network hierarchical structure, client terminals are “parents” and others are “children”.

10. Communications network for the diffusion of multimedia content according to claim 6, wherein—the client terminals are PC type computers.

11. Communication network for the diffusion of multimedia content according to claim 6, wherein the client terminals are network terminals.

12. Communication network for the diffusion of multimedia content according to claim 11 wherein the terminals are telephony terminals.

13. Communication network for the diffusion of multimedia content according to claim 12 wherein the telephony terminals are DECT compatible.

14. Communications network for the diffusion of multimedia content according to claim 9 wherein in the case of a fault on a client terminal, its children are able to reconnect to said private central server, or to the parent of the faulty terminal.
